(19) United States
(12) Patent Application Publication
(10) Pub. No.: US 2019/0217821 A1
(43) Pub. Date: Jul. 18, 2019

(54) WINDSHIELD WIPER SYSTEM AND METHOD OF USE

(71) Applicant: Anthony Leardi, Lincoln Park, NJ (US)

(72) Inventor: Anthony Leardi, Lincoln Park, NJ (US)

(21) Appl. No.: 16/156,792

(22) Filed: Oct. 10, 2018

Related U.S. Application Data
(60) Provisional application No. 62/618,802, filed on Jan. 18, 2018.

(51) Int. Cl. B60S 1/40; B60S 5/00

(52) U.S. Cl. CPC B60S 1/40; B60S 5/00

(57) ABSTRACT

A windshield wiper system eliminates the complex, cumbersome or difficult replacement of wiper blades. A connector mates with the standard wiper arm on automobiles of all types and contains a shaft prominent towards the windshield side. The shaft nests in the channel of a wiper. The wiper can then be attached and removed by a pulling or squeezing action.

### BACKGROUND

### 1. Field of the Invention

The present invention relates generally to automotive systems, and more specifically, to vision screen systems for preserving and augmenting the ability of a driver to view the road or way ahead.

### 2. Description of Related Art

Automotive systems are well known in the art and are effective means to use an engine to propel a vehicle or person from one place to another. For example, FIG. 1 depicts a conventional automobile system 101 having a frame 103 having tires 105 mounted to it. A driver 107 sits within the frame 103 and views the way ahead through a windshield 109. The windshield 109 is kept clear by a wiper system 111. During use, when the windshield 109 becomes spotted or obstructed the wiper 111 moves across the windshield 109 to remove the spotting or obstruction.

One of the problems commonly associated with system 101 is its limited efficiency. For example, changing a wiper 111 the no longer functions can be cumbersome as the wipers 111 are over the windshield 109 and away from the edge of the frame 103 of the automobile 101.

Accordingly, although great strides have been made in the area of automobile wiper systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a common automobile system;

FIG. 2 is a top view of a windshield wiper system in accordance with a preferred embodiment of the present application;

FIG. 3A and 3B are top views of the system of FIG. 2 in use;

FIG. 4 is a top view of the contemplated embodiment of the connector of FIG. 2; and

FIG. 5 is a flowchart of the preferred method of use of the system of FIG. 2.

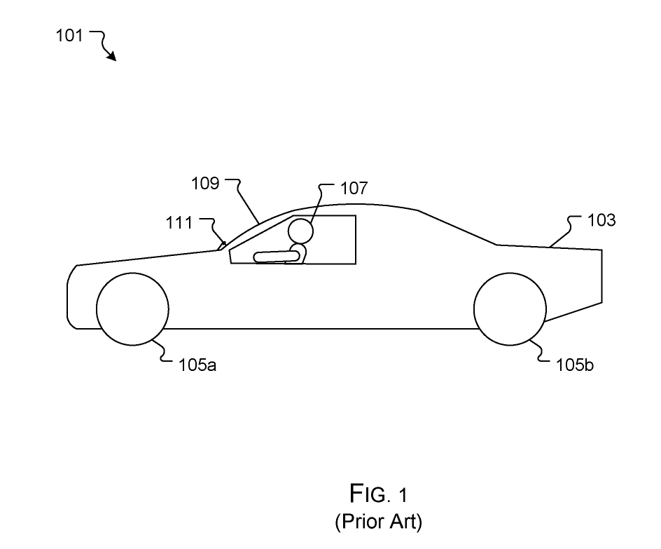

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional automobile wiper systems. Specifically, the invention of the present application facilitates the replacement of used or ineffective wipers. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

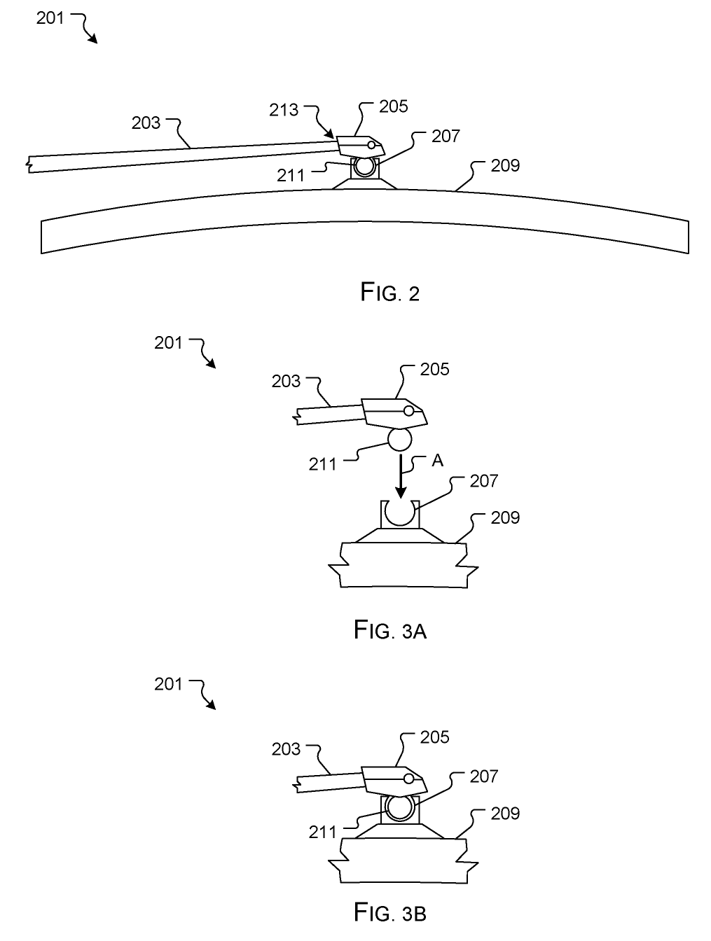

Referring now to the drawings wherein like reference characters identify corresponding or similar elements throughout the several views, FIG. 2 depicts a top view of a windshield wiper system in accordance with a preferred embodiment of the present application. It will be appreciated that system 201 overcomes one or more of the above-listed problems commonly associated with conventional automobile wiper systems.

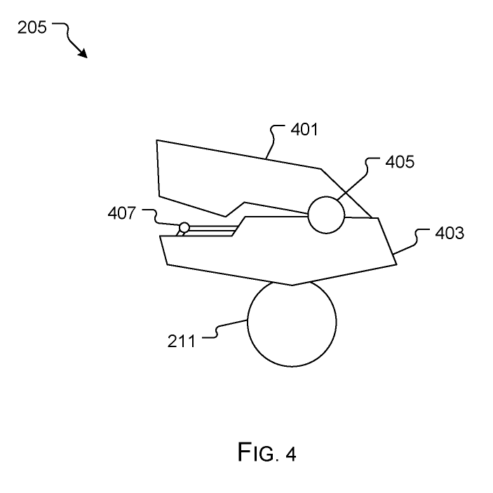

In the contemplated embodiment, system 201 includes a wiper arm 203 having a connector 205 at one end 213. The connector 205 has a cylindrical body 211 integral thereto and configured to mate with a channel 207 of a wiper 209. Referring to FIGS. 3A and 3B the connector 205 is depicted attaching to the wiper 209 via the cylindrical body 211 pressed in channel 207 as depicted by motion A.

It should be appreciated that one of the unique features believed characteristic of the present application is that the wiper 209 is removed from wiper arm 203 by a pulling action and that this action enables the efficient removal and replacement of the wiper 209.

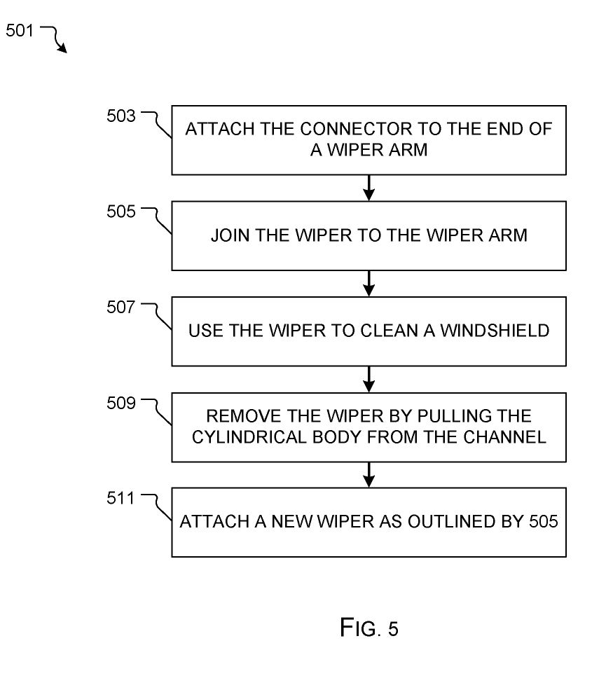

The contemplated embodiment of the connector 203 is depicted by FIG. 4 having an outer shell 401 attached to an inner shell 403 via a hinge 405. The inner hinge 403 configured to attach to the existing joint of the wiper arm 203 via a lock 407. Once attached the upper shell 401 secures the wiper arm 203 in place with respect to the inner shell 403. The inner shell 403 having the cylindrical body 211 integral thereto.

Referring now to FIG. 5 the preferred method of use of the system 201 is depicted. Method 501 includes attaching the connector to the end of a wiper arm 503, joining the wiper to the wiper arm by pressing the cylindrical body in the channel 505, using the wiper to clean a windshield 507, removing the wiper by pulling the cylindrical body from the channel 509 and attaching a new wiper as outlined by 505 to the connector 511.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed;:

1. A windshield wiper system comprising:
a connector configured to attach to a wiper arm; and
the connector having a cylindrical body integral thereto;
a wiper having a channel configured to accept the cylindrical body of the connector;
wherein the wiper and connector are attached by force in one direction.

2. The method of placing and removing a wiper given the system of claim 1, comprising:
attaching the connector to the end of a wiper arm;
joining the wiper to the wiper arm by pressing the cylindrical body in the channel;
using the wiper to clean a windshield;
removing the wiper by pulling the cylindrical body from the channel; and
attaching a new wiper as outlined by 505 to the connector.
